(19) United States
(12) Patent Application Publication
(10) Pub. No.: US 2012/0222269 A1
(43) Pub. Date: Sep. 6, 2012

(54) PORTABLE ASSIST HANDLE FOR VEHICLE ENTRY AND EXIT

(76) Inventor: STEVEN L. ANDERSON, Scottsville, KY (US)

(21) Appl. No.: 13/039,900

(22) Filed: Mar. 3, 2011

(51) Int. Cl. B60N 3/02

(52) U.S. Cl. 16/422

(57) ABSTRACT

The portable assist handle for vehicle entry and exit is removably installable across the span of an open vehicle door to facilitate the entry and exit of a person from the vehicle. The device includes a central tubular member and a closed handgrip portion extending therefrom. The handgrip portion may include a resilient cover to provide a better grip for the user. Two mutually opposed arms extend from the opposite ends of the central tubular member. The arms adjust telescopically and lock at the desired length to adjust for the open doorway span. Each arm has an adjustable grip extending therefrom, one grip being oriented to grip the edge of the vehicle roof at the door opening and the other grip being oriented to grip the upper edge of the frame of the vehicle door. The grips are easily secured and loosened to allow removal for storage.

### BACKGROUND OF THE INVENTION

1. Field of the Invention

The present invention relates to automotive accessories, and particularly to a portable assist handle for vehicle entry and exit to assist the elderly and handicapped when entering and exiting a vehicle.

2. Description of the Related Art

Most motor vehicles can present entry and exit difficulties for many people, particularly the elderly and/or physically handicapped. Most automobiles are constructed rather low to the ground, in order to provide better handling and to reduce material costs and aerodynamic drag and to increase fuel mileage. The resulting low seating position and the limited door opening can make it difficult for many people to enter such a motor vehicle, and perhaps even more difficult to leave the vehicle from a low seated position to a standing position. The lack of a secure handhold in conventional automobiles increases the difficulty further.

However, many larger pickup trucks, sport utility vehicles, and vans tend to be configured toward the opposite extreme, with relatively tall thresholds and even taller seating. Many elderly and/or physically handicapped people find great difficulty in entering such relatively tall vehicles, and may experience even more difficulty when stepping down from the high threshold of the vehicle onto the ground when exiting the vehicle. As in the case of standard automobiles, there is generally no means for a person to grasp a secure structure with his or her hand(s) when entering or exiting such a vehicle, to assist the entry or exit.

Many people are confined to wheelchairs, either as a temporary situation while recovering from an injury or illness, or as a permanent means of conveyance. It is even more difficult for such a person confined to a wheelchair to enter and exit a motor vehicle, for the reasons described above. Most people confined to a wheelchair have reasonable upper body strength, but they are unable to use such strength when entering or exiting most motor vehicles due to the lack of a secure structure for them to grasp.

Thus, a portable assist handle for vehicle entry and exit solving the aforementioned problems is desired.

### SUMMARY OF THE INVENTION

The portable assist handle for vehicle entry and exit includes a tubular central component having a handgrip extending therefrom, the central component and its handgrip forming a generally rectangular, closed tubular structure. The handgrip may include a resilient cover to facilitate gripping the device. An extension arm telescopes from each end of the central component, and has a locking mechanism securing the extension arms at the desired settings. Each arm has a grip extending from its distal end. The grips preferably are adjustable for both angular orientation relative to their extensions and also for their closures. One of the grips may project axially from its extension arm in order to better grip the upper edge of the door opening at the roof of the vehicle, while the other grip may project radially downwardly from its extension arm to grip the upper edge of the frame of the open door. The grips are easily opened for removal of the device from the door opening, allowing the device to be stored conveniently in the vehicle when not needed.

These and other features of the present invention will become readily apparent upon further review of the following specification and drawings.

### BRIEF DESCRIPTION OF THE DRAWINGS

FIG. 1 is an environmental, perspective view of a portable assist handle for vehicle entry and exit according to the present invention, illustrating temporary placement of the handle across the door and door opening of a motor vehicle.

FIG. 2 is a detailed perspective view of a portable assist handle for vehicle entry and exit according to the present invention, illustrating further details thereof.

Similar reference characters denote corresponding features consistently throughout the attached drawings.

### DETAILED DESCRIPTION OF THE PREFERRED EMBODIMENTS

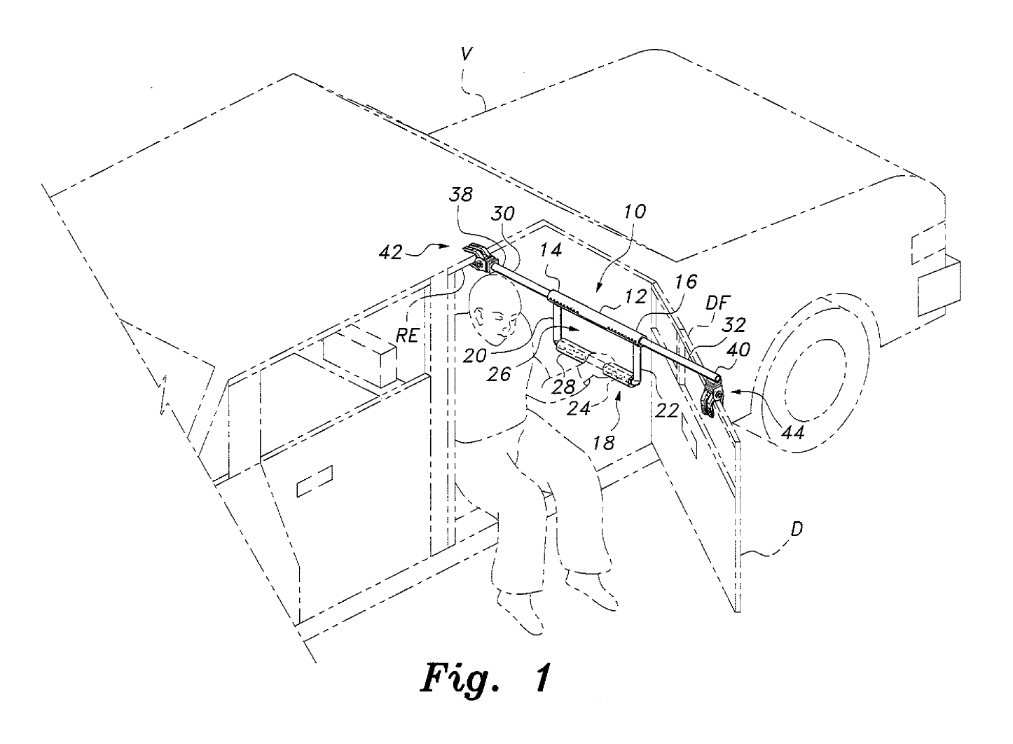

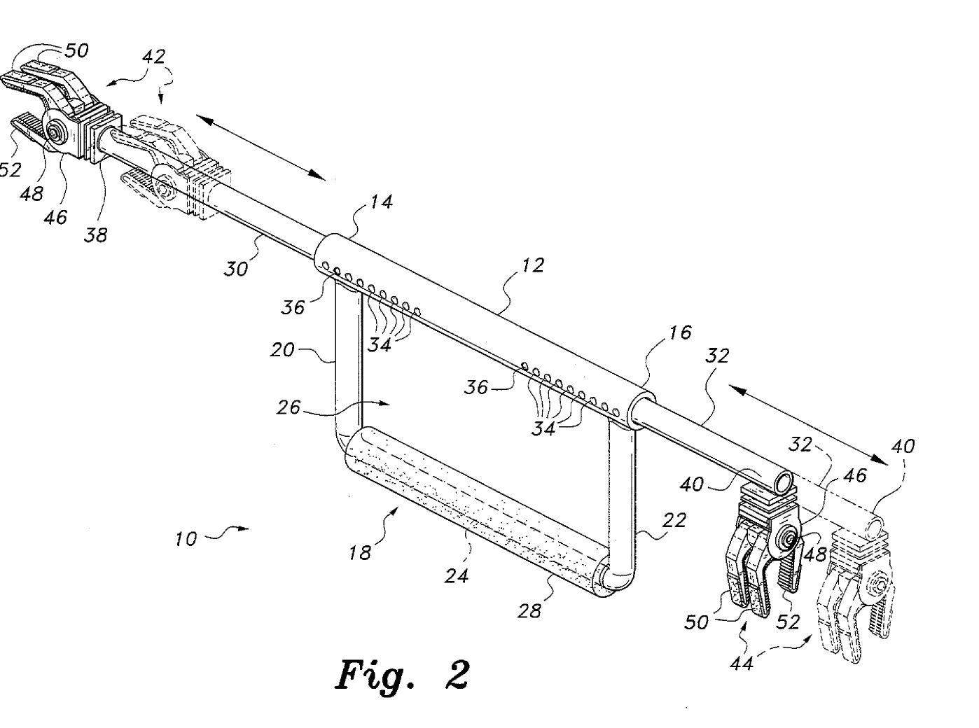

The portable assist handle for vehicle entry and exit generally comprises a tubular bar structure that may be placed across the span between the open door and the body structure of a motor vehicle to provide an additional handhold for persons entering or exiting the vehicle. FIGS. 1 and 2 of the drawings provide environmental perspective and detailed perspective views, respectively, of the portable assist handle 10, illustrating its use and details of construction. The portable assist handle 10 includes an elongate central member 12 having a first end 14 and an opposite second end 16. A C-shaped handgrip member 18 extends from the central member 12. The handgrip member 18 has mutually opposed first and second end components, respectively 20 and 22, attached to (e.g., welded, etc.) and extending orthogonally from the respective first and second ends 14 and 16 of the central member 12. An elongate handle member 24 extends between the two end components 20, 22 of the handgrip member 18. The central member 12, the two end components 20 and 22, and the handle member 24 form a closed handgrip passage 26 therein. A sleeve 28 formed of a relatively soft and resilient material having a high coefficient of friction (e.g., natural or artificial rubber) to provide good grip is preferably disposed over the handle member 24.

First and second cantilever arms 30 and 32 extend coaxially from the respective first and second ends 14 and 16 of the central member 12. The two cantilever arms 30 and 32 are tubular components having outer diameters equal to or slightly smaller than the inner diameter of the tubular central member 12, enabling the two cantilever arms 30 and 32 to telescope inwardly and outwardly from the central member 12 to adjust the span of the portable assist handle 10. The central member 12 includes a series of lock passages 34 therealong, as shown more clearly in FIG. 2, and each of the arms 30 and 32 has a conventional detent or lock pin 36 resiliently biased (e.g., internal spring, etc.) radially outwardly from its arm 30 and 32. The lock or detent pins 36 of the arms 30 and 32 selectively engage one of the lock passages 34 of the central member 12 to lock the extended length of each arm 30 and 32 to span the door opening of the vehicle, generally as shown in FIG. 1 of the drawings. FIG. 2 shows the first arm 30 extended to its maximum extent in solid lines, its retracted position being shown in broken lines. Conversely, the second arm 32 is shown retracted in solid lines and extended in broken lines in FIG. 2.

Each arm 30 and 32 has a distal end 38, 40. First and second vehicle structure grips 42 and 44 extend from the respective distal ends 38 and 40 of the two arms 30 and 32. Each of these grips 42 and 44 comprises a central hub 46 having an axial pivot pin 48 extending therethrough. A pair of first pincers or fingers 50 extends pivotally from the hub 46 and its pivot pin 48, and a single second finger 52 extends pivotally from the hub 46 and pivot pin 48 generally opposite the first finger pair 50. The fingers 50 and 52 are adjustable about their pivot pin 48, and may be closed together to grip an object (e.g., a vehicle door frame) therebetween.

FIG. 1 provides a perspective view of an exemplary temporary installation and use of the portable assist handle 10. In FIG. 1, the door D of a motor vehicle V is shown open for passenger ingress or egress, as the case may be. The portable assist handle 10 is shown extended across the open span between the vehicle door D and the vehicle V. The first vehicle structure grip 42 is secured to the roof edge RE of the vehicle V, and the second vehicle structure grip 44 is secured to the upper door frame DF of the vehicle V. While the two vehicle structure grips 42 and 44 can rotate about axes orthogonal to their pivot pins 48, they have limited articulation in other axes. Accordingly, the first vehicle structure grip 42 is affixed to the distal end 38 of the first arm 30 so that the axis of the pivot pin 48 is orthogonal to the axis of the arm 38 so that the fingers 50 and 52 extend substantially straight out from the arm 30 to better grip the roof edge RE of the vehicle V. Conversely, the opposite second vehicle structure grip 44 is affixed to the distal end 40 of the second arm 32 with the axis of its pivot pin 48 substantially parallel to the axis of its arm 32, and offset therefrom. This allows the grip fingers 50 and 52 to be rotated about an axis orthogonal to the second arm 32 to allow the space between the fingers 50 and 52 to pass over the edge of the upper door frame DF of the vehicle V when the door is opened at an angle to the side of the vehicle V, as shown in FIG. 1. The fingers 50 and 52 of the two vehicle structure grips 42 and 44 are then secured to grip the vehicle structure securely, thereby providing a secure handhold for a person entering or exiting the vehicle V, as shown in FIG. 1. When the person is seated in the vehicle V or has left the vehicle V, the two vehicle structure grips 42 and 44 are loosened, the two arms 30 and 32 are retracted for storage, and the portable assist handle 10 is stored in the vehicle V or elsewhere until needed again.

The portable assist handle 10 may be constructed from a wide variety of materials and material configurations. In the exemplary assist handle 10 illustrated in FIGS. 1 and 2, the central member 12, handgrip member 18 and its various components, and the two arms 30 and 32 are all formed of tubular material having circular cross sections. While it is essential for the central member 12 to be formed of hollow material in order for the arms 30 and 32 to telescope therein, it will be seen that the arms and the handgrip member may be formed of solid material, if desired, and/or any of the above components may be formed of materials having non-circular cross section, if desired, so long as the arms 30 and 32 can telescope within the central member 12. The various components comprising the assist handle 10 are preferably formed of a lightweight, durable metal, e.g., aluminum, although an even stronger metal, such as titanium may be used, or a standard steel or corrosion-resistant steel may be used if weight is not a problem. Alternatively, certain very strong plastics may be suitable for use in forming some of the components of the assist handle 10.

It is to be understood that the present invention is not limited to the embodiments described above, but encompasses any and all embodiments within the scope of the following claims.

I claim:

1. A portable assist handle for vehicle entry and exit, comprising:
an elongate central member having a first end and a second end opposite the first end;
a C-shaped handgrip member extending from the central member;
a first cantilever arm extending coaxially from the first end of the central member, the first cantilever arm having a distal end;
a second cantilever arm extending coaxially from the second end of the central member, the second cantilever arm having a distal end;
a first vehicle structure grip extending from the distal end of the first cantilever arm; and
a second vehicle structure grip extending from the distal end of the second cantilever arm.

2. The portable assist handle for vehicle entry and exit according to claim 1, wherein each said cantilever arm is telescopically adjustable from the respective end of the central member.

3. The portable assist handle for vehicle entry and exit according to claim 1 wherein each said vehicle structure grip comprises a hub having at least one first finger and at least one second finger extending therefrom, the first finger and the second finger being pivotally opposed to one another.

4. The portable assist handle for vehicle entry and exit according to claim 1, wherein the central member further includes a plurality of lock passages disposed therealong; and each said cantilever arm has a detent pin resiliently and radially disposed outwardly therefrom, the detent pins selectively engaging one of the lock passages of the central member.

5. The portable assist handle for vehicle entry and exit according to claim 1, wherein the central member, the handgrip member, and each said cantilever arm are formed of lengths of hollow tube.

6. The portable assist handle for vehicle entry and exit according to claim 1, further comprising a resilient, high friction handgrip disposed upon the C-shaped handgrip member.

7. The portable assist handle for vehicle entry and exit according to claim 1, wherein the central member, the handgrip member, and each said cantilever arm are formed of materials selected from the group consisting of metal and plastic.

8. A portable assist handle for vehicle entry and exit, comprising:
an elongate central member having a first end and a second end opposite the first end;
an adjustable first cantilever arm telescopically extending coaxially from the first end of the central member, the first cantilever arm having a distal end;
an adjustable second cantilever arm telescopically extending coaxially from the second end of the central member, the second cantilever arm having a distal end;
a first vehicle structure grip extending from the distal end of the first cantilever arm; and
a second vehicle structure grip extending from the distal end of the second cantilever arm.

9. The portable assist handle for vehicle entry and exit according to claim 8 further comprising a C-shaped handgrip member extending from the central member.

10. The portable assist handle for vehicle entry and exit according to claim 9, further comprising a resilient, high friction handgrip disposed upon the C-shaped handgrip member.

11. The portable assist handle for vehicle entry and exit according to claim 8 wherein each said vehicle structure grip comprises a hub having at least one first finger and at least one second finger extending therefrom, the first finger and the second finger being pivotally opposed to one another.

12. The portable assist handle for vehicle entry and exit according to claim 8, wherein the central member further includes a plurality of lock passages disposed therealong; and each said cantilever arm has a detent pin resiliently and radially disposed outwardly therefrom, the detent pins selectively engaging one of the lock passages of the central member.

13. The portable assist handle for vehicle entry and exit according to claim 8, wherein the central member and each said cantilever arm are formed of lengths of hollow tube.

14. The portable assist handle for vehicle entry and exit according to claim 8, wherein the central member and each said cantilever arm are formed of materials selected from the group consisting of metal and plastic.

15. A portable assist handle for vehicle entry and exit, comprising:
an elongate central member having a first end and a second end opposite the first end;
a first cantilever arm extending coaxially from the first end of the central member, the first cantilever arm having a distal end;
a second cantilever arm extending coaxially from the second end of the central member, the second cantilever arm having a distal end;
a first vehicle structure grip extending from the distal end of the first cantilever arm; and
a second vehicle structure grip extending from the distal end of the second cantilever arm, each of the vehicle structure grips having a hub and at least one first finger and at least one second finger extending from the hub, the first finger and the second finger being pivotally opposed to one another.

16. The portable assist handle for vehicle entry and exit according to claim 15 further comprising:
a C-shaped handgrip member extending from the central member; and
a resilient, high friction handgrip disposed upon the C-shaped handgrip member.

17. The portable assist handle for vehicle entry and exit according to claim 15, wherein each said cantilever arm is telescopically adjustable from the respective end of the central member.

18. The portable assist handle for vehicle entry and exit according to claim 15, wherein the central member further includes a plurality of lock passages disposed therealong; and each said cantilever arm has a detent pin resiliently and radially disposed outwardly therefrom, the detent pins selectively engaging one of the lock passages of the central member.

19. The portable assist handle for vehicle entry and exit according to claim 15, wherein the central member and each said cantilever arm are formed of lengths of hollow tube.

20. The portable assist handle for vehicle entry and exit according to claim 15, wherein the central member and each said cantilever arm are formed of materials selected from the group consisting of metal and plastic.
